(19) United States
(12) Patent Application Publication
(10) Pub. No.: US 2015/0101119 A1
(43) Pub. Date: Apr. 16, 2015

(54) PORTABLE MODULAR WATER DISPENSING SYSTEMS

(71) Applicant: Products and Things Pty Ltd, Bulli (AU)

(72) Inventors: Nicholas William Robinson, Latham (AU); Nicholas John Roseby, Bulli (AU)

(73) Assignee: Products and Things Pty Ltd, Bulli (AU)

(21) Appl. No.: 14/051,515

(22) Filed: Oct. 11, 2013

(51) Int. Cl. A47K 3/28

(52) U.S. Cl. CPC B67D 7/78; B67D 7/36
USPC 4/596

(57) ABSTRACT

A water module system. A water module can include a water dispensing fixture, a water supply bypass connecting two valved water supply inlet/outlet ports, and a water supply branch connecting the water dispensing fixture to the water supply bypass. The water supply bypass can be connectable to a further water module having at least a further water dispensing fixture. In use, water can be supplied from the water module to the further water module in series. The system can be portable, modular, and/or scalable.

### FIELD

The present invention relates to portable modular water dispensing systems.

### BACKGROUND

Persons attending public events such as sporting events, outdoor events, festivals and concerts require water for drinking, washing, cleaning, cooling and recreation. The existing fixed public water dispensing infrastructure of taps, bubblers, showers and fountains at such events is typically inadequate for the large number of persons attending them.

In this context, there is a need for solutions to provide portable modular water dispensing systems that are scalable for large public events.

### SUMMARY

According to the present invention, there is provided a system, comprising:
a water module comprising:
   a water dispensing fixture;
   a water supply bypass connecting two valved water supply inlet/outlet ports; and
   a water supply branch connecting the water dispensing fixture to the water supply bypass;
   wherein the water supply bypass of the water module is connectable to a further water module having at least a further water dispensing fixture, so that, in use, water is supplied from the water module to the further water module in series.

The water modules may be selected from a group comprising a water filling station, a bubbler, a shower, a tap, a sprinkler, a hose, a mist generator, a fountain, a sprayer, and a washing station.

The water module may further comprise:
a water drain;
a water drain bypass connecting two valved water drain inlet/outlet ports; and
a water drain branch connecting the water drain to the water drain bypass;
wherein the water drain bypass of the water module is connectable to the further water module, so that, in use, water drains from the water module to the further water module in series.

The water module may be a portable water filling station comprising:
a housing; and
an aperture through the housing to receive a water container to be filled;
wherein the water dispensing fixture is a nozzle that projects down into the aperture, the water drain is in the aperture below the nozzle, and the water supply and water drain bypasses and inlet/outlet ports are provided in the housing.

The housing may be rectangular in shape. The housing may have front and rear panels with a top, bottom and sides. The front and rear panels may be removable. The front and rear panels may be adapted to display advertising.

The aperture may have a bottle shape.

The water filling station may further comprise a stand that is removably connectable to the bottom of the housing.

The water filling station may further comprise one or more taps to actuate water flow through the nozzle. The one or more taps may comprise a first tap on top of the housing, and a second tap on one side of the housing.

The water supply branch may comprise a water filter connected between the water supply bypass and the nozzle. The water supply branch may further comprise a water meter connected between the water supply bypass and the nozzle.

The system may further comprise press-on fittings and flexible tubing to respectively connect the water supply and water drain bypasses of the water module and the further water module to one another, a water supply and a drain.

### BRIEF DESCRIPTION OF DRAWINGS

Embodiments of the invention will now be described by way of example only with reference to the accompanying drawings, in which:

FIG. 1 is a perspective view of an example portable water dispensing module of a portable modular water dispensing system according to an example embodiment;

FIGS. 2A to 2D are front, left hand side, right hand side, and top views respectively of the portable water dispensing module;

FIG. 3 is a schematic diagram of plumbing of the portable water dispensing module;

FIG. 4 is an exploded perspective view of the portable water dispensing module;

FIGS. 5A and 5B are front views of example configurations of the portable modular water dispensing system;

FIG. 6 is a front view of a further example configuration of the portable modular water dispensing system;

FIG. 7 is a front view of another example configuration comprising a shower module connected to a portable water dispensing module; and

FIG. 8 is a front view of a further example configuration comprising a tap module connected to a portable water dispensing module.

### DETAILED DESCRIPTION

A portable modular water dispensing system according to an example embodiment may comprise one or more portable water dispensing modules connected to one another, a water supply (eg, mains or tank water) and a drain. The portable water dispensing modules may be selected from a group comprising a water filling station, a bubbler, a tap, a shower, a sprinkler, a hose, a mist generator, a fountain, a sprayer, and a washing station. Other equivalent portable water dispensing modules may also be used.

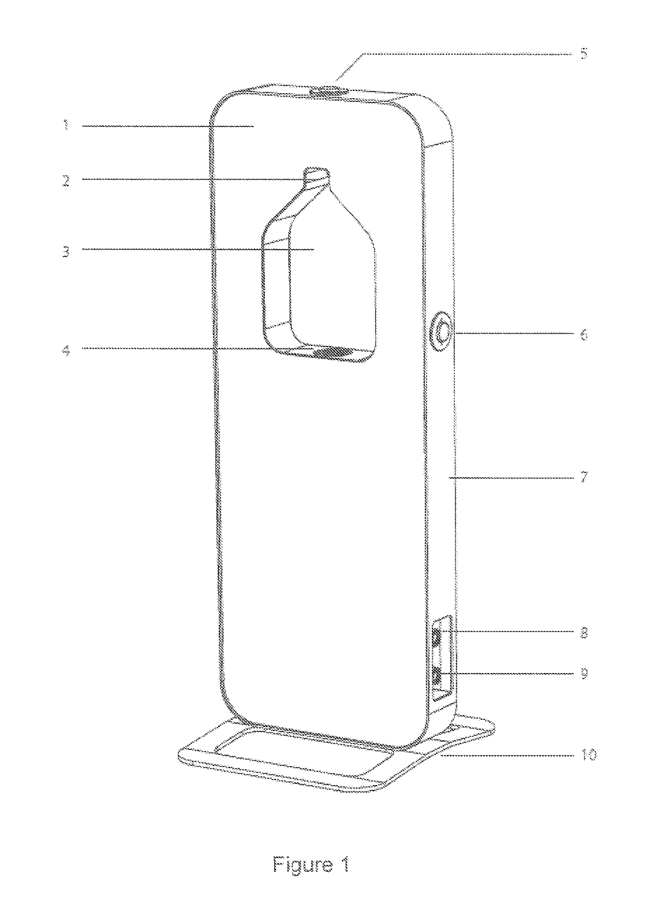

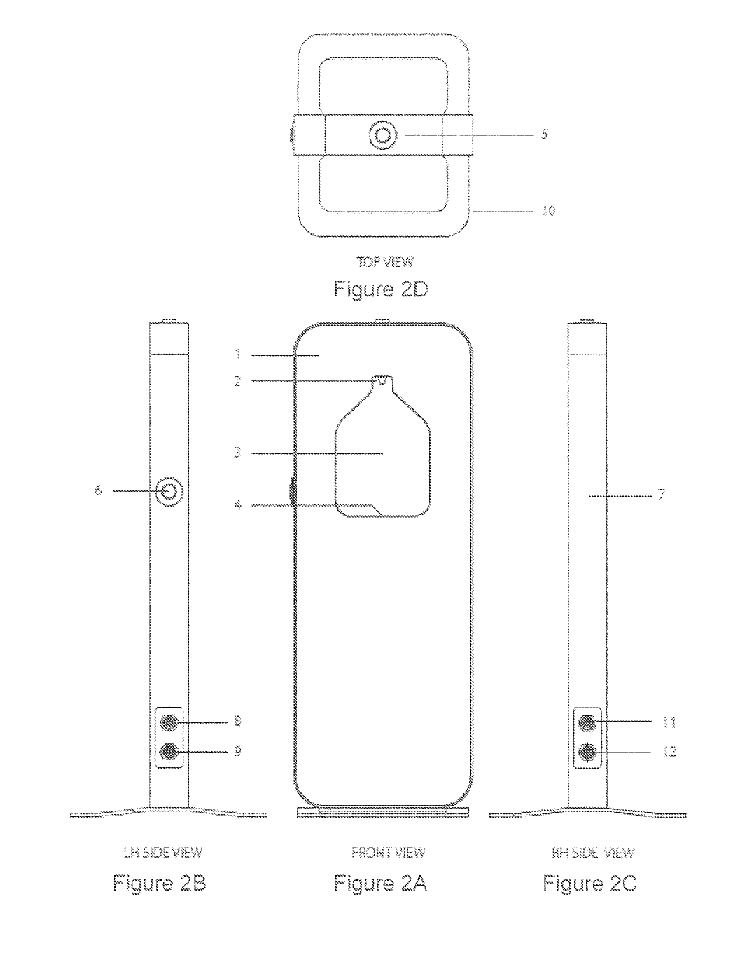

FIGS. 1 to 4 illustrate an example embodiment in which the portable water dispensing module is implemented by way of example only as a self-service water filling station. The water filling station may comprise a rectangular housing having front and rear panels 1 with a top, bottom and sides. The front and rear panels 1 may be removable. The front and rear panels 1 may display advertising or signage (not shown). The portable water filling station may further comprise a stand 10 that is removably connectable to the bottom of the housing. The portable water filling station is sized and dimensioned to pack into a carry bag (not shown) after the stand has been removed for transport and storage.

A bottle-shaped aperture 3 (or window) is provided through the housing to receive a water bottle or container (not shown) to be filled with drinking water. A dispensing nozzle 2 may project down into the aperture 3. A water drain 4 may be provided in the aperture 3 below the nozzle 2. The bottle-shaped aperture 3 enables a water bottle to be filled from either side of the housing. The downward tapering shape of the bottle-shaped aperture 3 helps align the water bottle opening with the nozzle 2, and also prevents the water bottle opening from touching the nozzle 2 to maintain hygiene.

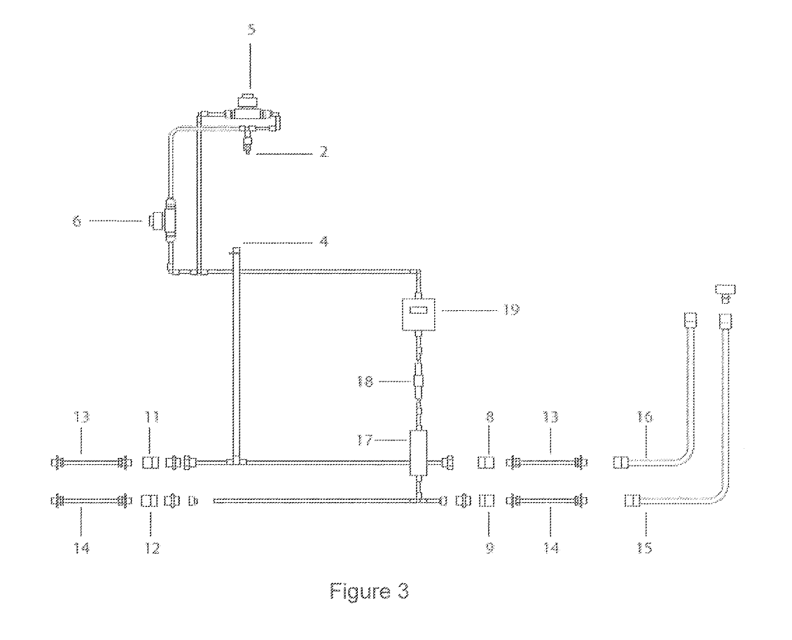

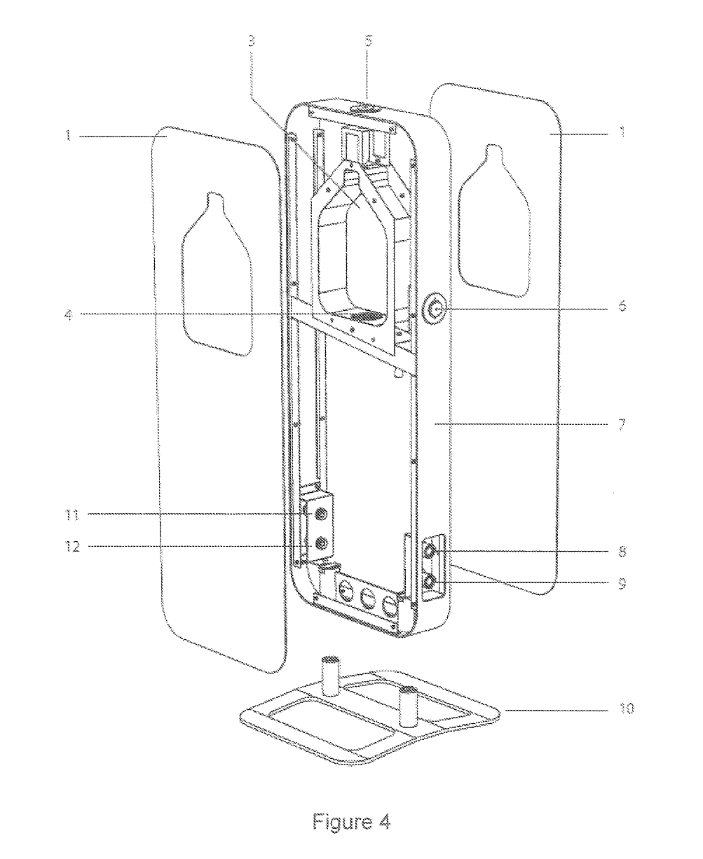

Referring to FIGS. 3 and 4, the plumbing of the water filling station may include a water supply bypass (or flow path) inside the housing to fluidly interconnect two valved water supply inlet/outlet ports 9, 12. As illustrated in FIG. 3, a water supply branch is provided inside the housing to fluidly connect the nozzle 2 to the water supply bypass between the water supply inlet/outlet ports 9, 12. The water supply branch may include a water filter 17, flow restrictor 18 and water meter 19 connected in series between the water supply bypass and the nozzle 2.

The water supply branch may further include first and second taps 5, 6 (eg, press-button taps) to actuate water flow from the water supply bypass to the nozzle 2. The first tap 5 may be provided on top of the housing, and the second tap 6 may be provided on one side of the housing. The side tap 6 allows water flow from the nozzle 2 to be actuated by children and wheelchair users.

The plumbing of the water filling station may further include a water drain bypass (or flow path) inside the housing to fluidly interconnect two valved water drain inlet/outlet ports 8, 11. A water drain branch is also provided inside the housing to fluidly connect the water drain 4 to the water drain bypass between the water drain inlet/outlet ports 8, 11.

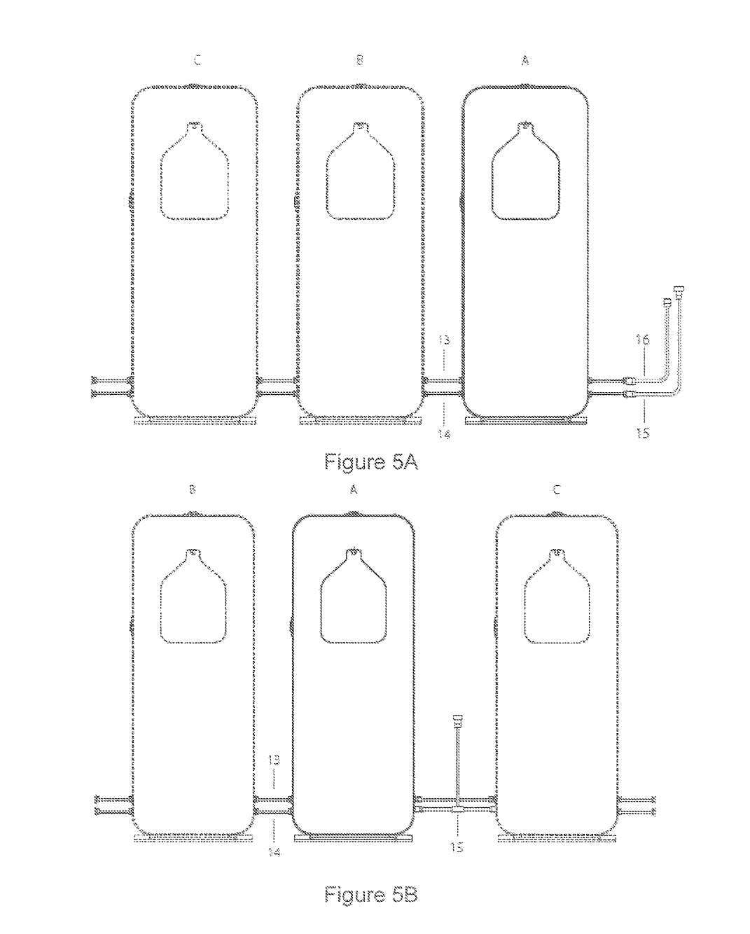

Referring to FIGS. 3, 5A and 5B, the system may further comprise press-on fittings and flexible tubing, hoses or piping to respectively fluidly connect the water supply and water drain bypasses of the water filling station to water supply and water drain bypasses of at least one further portable water dispensing module. Referring to FIG. 3, the flexible tubing may include flexible drain water hoses 13 and fresh water hoses 14 to respectively fluidly connect the water supply and water drain bypasses of the portable water filling station to a drinking water supply 15 (eg, mains or tank water) and a drain 16.

Each of the valved water supply and water drain inlet/outlet ports 9, 12, 8, 11 may comprise a stop valve (eg, a spring-loaded check or shut-off valve) to control pressurised or unpressurised water flow through the water supply and water drain bypasses when individual ports are not in use. For example, the stop valves of the water supply and water drain inlet/outlet ports 9, 12, 8, 11 may stop water flowing through the water supply and water drain bypasses of the portable water filling station unless fittings and hoses are connected. The water drain stop valves may be spring-loaded to close under low or no pressure to prevent drain water leaking from the side of the portable water filling station when the water drain inlet/outlet port on that side is not in use.

FIGS. 5A and 5B illustrate different example modular system configurations of three portable water dispensing modules A, B, C fluidly connected to one another, a water source 15 and a drain 16. In each configuration, the portable water dispensing module A is connected to the water source 15 and acts as a water supply feed module to the other modules B, C. In FIG. 5A, the module A is also connected directly to the water drain 16. Alternatively, in FIG. 5B the module A may be indirectly connected to the water drain 16 by one of the other modules B, C. The water supply and water drain flows of each of the modules A, B, C are bidirectional in that the water supply hose 15 and the water drain hose 16 may be connected to an inlet/outlet port on either side of an individual module.

Each of the portable water dispensing modules A, B, C illustrated in FIGS. 5A and 5B are implemented by way of example only as portable water filling stations. It will be appreciated that one or more of the portable water dispensing modules A, B, C may be implemented in different combinations of portable water dispensing modules selected from a group comprising a water filling station, a bubbler, a shower, a tap, a sprinkler, a hose, a mist generator, a fountain, a sprayer, a washing station, etc.

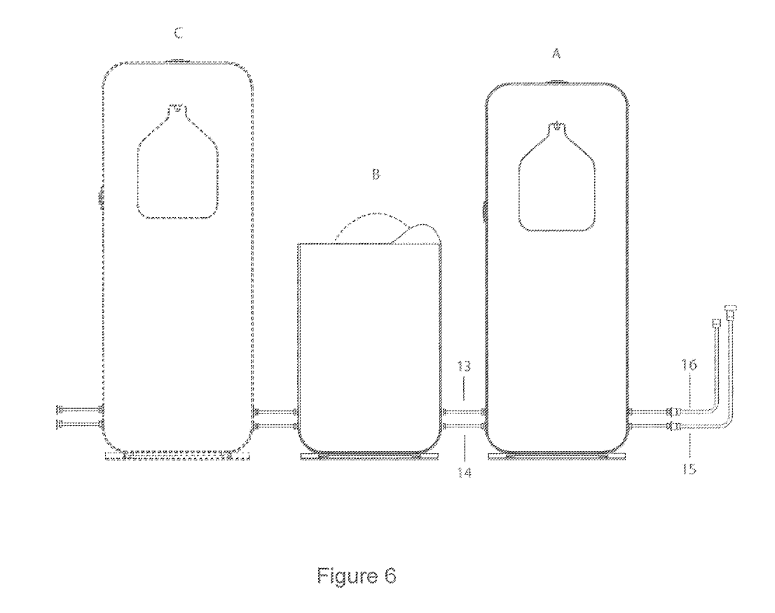

For example, FIG. 6 illustrates an example system configuration in which a central module B may be implemented as a water bubbler between two portable water filling stations A, C. In this example, the water supply and water drain bypasses of modules A, B, C are connected together so that, in use, water is both supplied and drained in series through modules A, B, C.

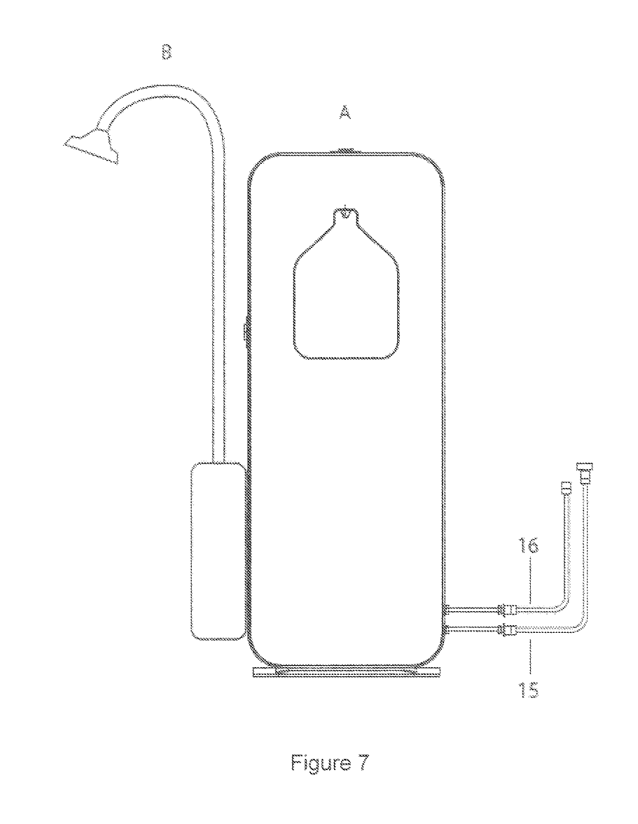

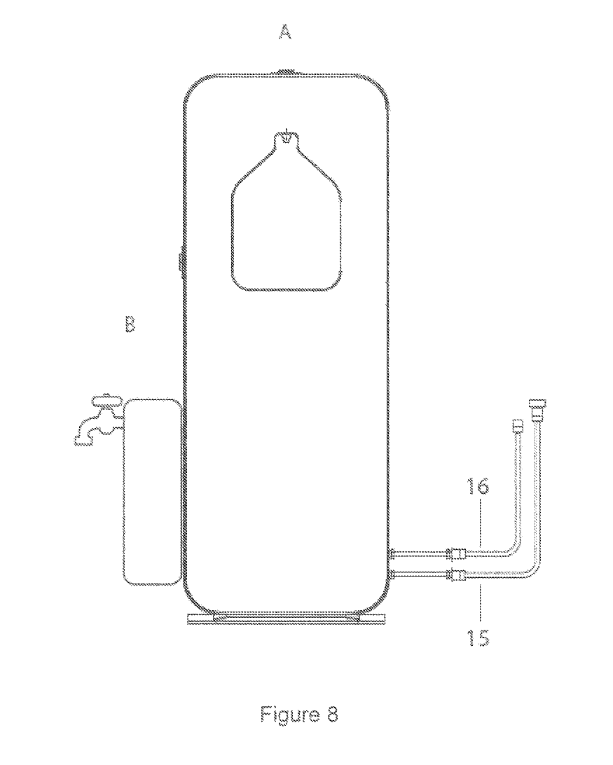

FIGS. 7 and 8 illustrate further example system configurations in which module B is implemented as a shower and a tap, respectively, connected to a portable water filling station A. In these examples, the water supply inlet of each module B is connected to the water supply bypass of module A so that, in use, water is supplied from module A to module B in series.

Embodiments of the method of the present invention provide scalable, modular and portable water dispensing systems that are a useful addition or alternative to fixed public water dispensing infrastructure at public events.

The above embodiments have been described by way of example only and modifications are possible within the scope of the claims that follow.

1. A system, comprising:
a water module comprising:
a water dispensing fixture;
a water supply bypass connecting two valved water supply inlet/outlet ports; and
a water supply branch connecting the water dispensing fixture to the water supply bypass;
wherein the water supply bypass of the water module is connectable to a further water module having at least a further water dispensing fixture, so that, in use, water is supplied from the water module to the further water module in series.

2. A system according to claim 1, wherein the water modules are selected from a group comprising a water filling station, a bubbler, a shower, a tap, a sprinkler, a hose, a mist generator, a fountain, a sprayer, and a washing station.

3. A system according to claim 1, wherein the water module further comprises:
a water drain;
a water drain bypass connecting two valved water drain inlet/outlet ports; and
a water drain branch connecting the water drain to the water drain bypass;
wherein the water drain bypass of the water module is connectable to the further water module, so that, in use, water drains from the water module to the further water module in series.

4. A system according to claim 3, wherein the water module is a portable water filling station comprising:
a housing; and
an aperture through the housing to receive a water container to be filled;
wherein the water dispensing fixture is a nozzle that projects down into the aperture, the water drain is in the aperture below the nozzle, and the water supply and water drain bypasses and inlet/outlet ports are provided in the housing.

5. A system according to claim 4, wherein the housing is rectangular in shape.

6. A system according to claim 5, wherein the housing has front and rear panels with a top, bottom and sides.

7. A system according to claim 6, wherein the front and rear panels are removable.

8. A system according to claim 7, wherein the front and rear panels are adapted to display advertising.

9. A system according to claim 4, wherein the aperture has a bottle shape.

10. A system according to claim 4, wherein the water filling station further comprises a stand that is removably connectable to the bottom of the housing.

11. A system according to claim 4, wherein the water filling station further comprises one or more taps to actuate water flow through the nozzle.

12. A system according to claim 11, wherein the one or more taps comprise a first tap on top of the housing, and a second tap on one side of the housing.

13. A system according to claim 4, wherein the water supply branch comprises a water filter connected between the water supply bypass and the nozzle.

14. A system according to claim 13, wherein the water supply branch further comprises a water meter connected between the water supply bypass and the nozzle.

15. A system according to claim 3, further comprising press-on fittings and flexible tubing to respectively connect the water supply and water drain bypasses of the water module and the further water module to one another, a water supply and a drain.
